(19) United States
(12) Patent Application Publication
(10) Pub. No.: US 2007/0193683 A1
(43) Pub. Date: Aug. 23, 2007

(54) Continuous pressed laminates

(75) Inventor: Robert Huusken, DeLutte (NL)

Correspondence Address: OWENS CORNING, 2790 COLUMBUS ROAD, GRANVILLE, OH, 43023, US

(73) Assignee: Halo LSI, Inc.

(21) Appl. No.: 11/357,474

(22) Filed: Feb. 17, 2006

(51) Int. Cl. C09J 5/02

(52) U.S. Cl. 156/307.3; 428/219

(57) ABSTRACT

A continuous pressed laminate includes a first layer of resin impregnated paper and at least one layer of fiber reinforced veil wherein each layer of the fiber reinforced veil is impregnated with a binder and a filler composition and wherein the layer of fiber reinforced veil following impregnation and prior to pressing has a weight per unit area of between about 50 to about 1250 g/m².

### TECHNICAL FIELD AND INDUSTRIAL APPLICABILITY OF THE INVENTION

This invention relates generally to continuous pressed laminates and panels.

### BACKGROUND OF THE INVENTION

Continuous pressed laminates (CPL) are well known in the art. CPL panels are used for a number of purposes such as interior decorative applications including, but not limited to, interior fitting, building industry, transport industry, walls and the like. The continuous pressed laminates must provide a unique combination of processability, mechanical and fire properties in order to satisfactorily perform when used in these applications.

### SUMMARY OF THE INVENTION

The continuous pressed laminate of the present invention comprises a first layer of resin impregnated paper and at least one layer of fiber reinforced veil. Each layer of fiber reinforced veil is impregnated with a binder and a filler composition. Following impregnation and prior to pressing, each layer of fiber reinforced veil has a weight per unit area of between about 50 to about 1250 g/m², more typically between about 75 to about 750 g/m² and most typically between about 100 to about 600 g/m².

The CPL may be made from at least one layer of woven fiber reinforced veil, at least one layer of nonwoven fiber reinforced veil or at least one layer of woven and at least one layer of nonwoven fiber reinforced veil. Reinforcing fibers included in the veil may be selected from a group consisting of glass fibers, basalt fibers, silica fibers, inorganic fibers and mixtures thereof. Where glass fibers are used the fibers may be chopped strands, chopped rovings, chopped individual glass fibers or even mixtures thereof. Each layer of the fiber reinforced veil has a base weight per unit area of between about 20 to about 200 g/m², more typically between about 30 to about 120 g/m² and most typically between about 40 to about 100 g/m².

The impregnated fiber reinforced veil comprises between about 2 and about 50 weight percent reinforcement fiber, between about 10 and about 70 weight percent resin and between about 0 and about 80 weight percent filler. The resin is selected from a group of resins consisting of phenol formaldehyde, melamine formaldehyde, urea formaldehyde, crosslinkable acrylates, crosslinkable acrylics, self-crosslinkable acrylates, self-crosslinkable acrylics, epychlorohydrin polyamide, epychlorohydrin polyamine, epoxy and mixtures thereof. The filler is selected from a group of fillers consisting of aluminum trihydrate, calcium carbonate, magnesium hydroxide, metal hydroxides, metal carbonates, titanium oxide, calcined clay, barium sulfate, magnesium sulfate, aluminum sulfate, zinc oxide, kaolin clay, chlorite, diatomite, feldspar, mica, nepheline syenite, pyrophyllite, silica, talc, wollastonite, montmorillonite, hectorite, saponite, magnesium carbonate, aluminum oxide, iron oxide, ethylenediamine phosphate, guanidine phosphate, melamine borate, melamine (mono, pyro, poly) phosphate, ammonium (mono, pyro, poly) phosphate, dicyandiamide condensates, expandable graphite, glass micro beads and mixtures thereof.

The resin and filler composition includes between about 10 and about 60 weight percent resin and between about 0 and about 85 weight percent filler. A particularly useful resin is a phenol formaldehyde/melamine formaldehyde/hardener mixture provided at a ratio of about 25-75% 25-75%:2-20%. A particularly useful filler is selected from a group of fillers consisting of aluminum trihydrate, calcium carbonate, magnesium hydroxide and mixtures thereof.

The CPL may also include a layer of backing paper wherein the veil is sandwiched between the first layer of resin impregnated paper and the backing paper. A parchment paper may be used in place of the backing paper if desired. In a further embodiment a second layer of resin impregnated paper is provided with the veil sandwiched between the first and second layers of resin impregnated paper. That resin impregnated paper of those two layers may take the form of a melamine impregnated decorative paper.

In accordance with still another aspect of the present invention a method of making a CPL is provided. That method includes the pressing of a first layer of resin impregnated paper and at least one layer of fiber reinforced veil together at a pressure of between about 5 kg/cm² and about 60 kg/cm² while simultaneously heating the layers to a temperature of between about 120° C. and about 250° C. to produce a laminate. Following impregnation and prior to pressing, each layer of fiber reinforced veil has a weight per unit area of between about 50 to about 1250 g/m².

In the following description there is shown and described one embodiment of the invention, simply by way of illustration of one of the modes best suited to carry out the invention. As it will be realized, the invention is capable of other different embodiments and its several details are capable of modification in various, obvious aspects all without departing from the invention. Accordingly, the drawing and descriptions will be regarded as illustrative in nature and not as restrictive.

### BRIEF DESCRIPTION OF THE DRAWING

The accompanying drawing incorporated in and forming a part of this specification, illustrates several aspects of the present invention, and together with the description serves to explain certain principles of the invention. In the drawing:

FIG. 1 is a side elevational view of one possible embodiment of the present invention.

Reference will now be made in detail to the present preferred embodiment of the invention, an example of which is illustrated in the accompany drawing.

### DETAILED DESCRIPTION AND PREFERRED EMBODIMENT OF THE INVENTION

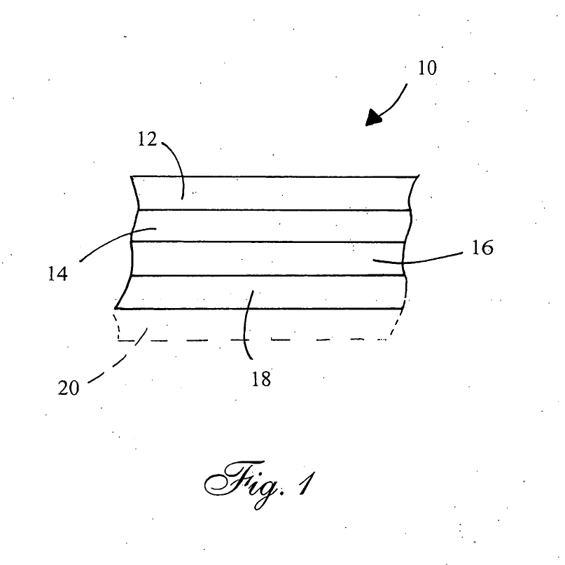

One possible embodiment of the continuous pressed laminate (CPL) 10 of the present invention is illustrated in FIG. 1. The CPL 10 may be generally described as comprising a first layer of resin impregnated paper and at least one layer of fiber reinforced veil that is impregnated with a binder and a filler composition. Each layer 14, 16, 18 of fiber reinforced veil has a weight per unit area of between about 50 to about 1250 g/m², more typically 75 to about 750 g/m² and most typically between about 100 to about 600 g/m² following impregnation and prior to pressing.

As illustrated in FIG. 1, the CPL 10 includes a first layer 12 of resin impregnated paper, such as melamine impregnated decorative paper, an electron beam or UV cured decorative paper or a thermally crosslinked urethane acrylate decorative paper. In addition, the CPL 10 includes three layers 14, 16, 18 of fiber reinforced veil.

The layers 14, 16, 18 of fiber reinforced veil include reinforcing fibers selected from a group consisting of glass fibers, basalt fibers, silica fibers, inorganic fibers (carbide, nitride, etc.) and mixtures thereof. Glass fibers particularly useful in the present invention include E-glass (such as ADVANTEX glass), ECR-glass, AR-glass, S-glass, M-glass, C-glass, S2-glass and mixtures thereof. The fibers are typically chopped in lengths of between about 0.1 mm and about 100 mm and may be in the form of chopped strands, chopped rovings or chopped individual fibers or mixtures thereof. Where individual fibers are utilized, the diameter of those fibers is typically between about 3 and about 50 microns.

The reinforcing fibers in each layer 14, 16, 18 may be woven or nonwoven in any combination. Accordingly, all three may be woven, any two may be woven while the third is nonwoven or any one may be woven while the other two are nonwoven. Still further, all three layers 14, 16, 18 may be nonwoven. The layers 14, 16, 18 may also vary in composition and/or thickness. For example, the layer 14 adhering to the resin impregnated paper layer 12 could have a composition providing enhanced fire performance whereas the layer 18 could have a composition to improve adhesion to other substrates where the laminate 10 is glued on in most applications. Each layer of the fiber reinforced veil 14, 16, 18 has a base weight per unit area of between about 20 to about 200 g/m², more typically between about 30 to about 120 g/m² and most typically between about 40 to about 100 g/m².

Each layer 14, 16, 18 of fiber reinforced veil is impregnated with a resin and filler composition. The resin is a heat curable resin. Typically the resin is selected from a group consisting of phenol formaldehyde, melamine formaldehyde, urea formaldehyde, crosslinkable acrylates, crosslinkable acrylics, self-crosslinkable acrylates, self-crosslinkable acrylics, epychlorohydrin polyamide, epychlorohydrin polyamine, epoxy and mixtures thereof. A particularly useful resin is a phenol formaldehyde/melamine formaldehyde/hardener mixture provided at a ratio of about 25-75%:25-75%:2-20%.

The filler is selected from a group consisting of aluminum trihydrate, calcium carbonate, magnesium hydroxide, metal hydroxides, metal carbonates, titanium oxide, calcined clay, barium sulfate, magnesium sulfate, aluminum sulfate, zinc oxide, kaolin clay, chlorite, diatomite, feldspar, mica, nepheline syenite, pyrophyllite, silica, talc, wollastonite, montmorillonite, hectorite, saponite, magnesium carbonate, aluminum oxide, iron oxide, ethylenediamine phosphate, guanidine phosphate, melamine borate, melamine (mono, pyro, poly) phosphate, ammonium (mono, pyro, poly) phosphate, dicyandiamide condensates, expandable graphite, glass micro beads and mixtures thereof. A filler selected from a group consisting of aluminum trihydrate, calcium carbonate, magnesium hydroxide and mixtures thereof is particularly useful in the present invention.

Typically the resin and filler composition includes between about 10 and about 60 weight percent resin and between about 0 and about 85 weight percent filler. When impregnated each layer 14, 16, 18 of the fiber reinforced veil comprises between about 2 and about 50 weight percent reinforcement fibers, between about 10 and about 70 weight percent resin and between about 0 and about 80 weight percent filler.

As further illustrated in FIG. 1, the CPL 10 may also include an optional layer 20 of backing paper, parchment paper or resin impregnated paper such as melamine impregnated decorative paper. As should be appreciated the layers 14, 16, 18 of fiber reinforced veil are sandwiched between the resin impregnated paper 12 and the optional layer 20.

If desired, the CPL 10 may also be made more aesthetically pleasing by including a radiation curable paint such as an electron beam cured or UV cured paint film on an otherwise exposed face of the first layer of resin impregnated paper 12. Alternatively, that layer may comprise a thermally cross-linked urethane acrylate paint. While the illustrated embodiment of the CPL 10 includes three layers 14, 16, 18 of fiber reinforced veil, it should be appreciated that substantially any number of layers of fiber reinforced veil may be provided depending on the needs of any particular application. This includes providing the CPL 10 with the desired processability, mechanical and fire properties.

Typically, each fiber reinforced veil layer 14, 16, 18 is a prepreg or ready-to-mold sheet of woven or nonwoven reinforcement fibers impregnated with a resin (substantially any binder for glass fibers may be used) and stored for subsequent use such as the final construction of a laminate product by a manufacturer. The prepreg is impregnated with the resin and filler composition. As noted above, following impregnation and before pressing, a typical fiber reinforced veil prepreg will have a weight per unit area of between about 50 to about 1250 g/m², more typically between about 75 to about 750 g/m² and most typically between about 100 to about 600 g/m². The prepreg will also include between about 10-70% resin.

The CPL 10 is constructed by pressing a first layer of resin impregnated paper and at least one layer of fiber reinforced veil 14, 16, 18 together at a pressure of between about 5 to about 60 kg/cm² while simultaneously heating the layers to a temperature of between about 120-250 degrees C. to form the laminate.

The laminates 10 of the present invention provide a number of benefits. The layers 14, 16, 18 of glass veil are more open than layers of paper typically used in prior art CPLs. As a consequence, less resin can be used in the laminates and this results in better fire performance. Further, the relatively open veil can absorb large amounts of fire performance enhancing fillers so that the properties of the laminates can be tuned to meet the needs of a particular application.

In addition, because the laminates 10 of the present invention incorporate a glass veil they provide a much longer resistance to flames. The glass veil layers 14, 16, 18 melt only at about 900 degrees C. and keep their structure longer than paper based laminates. This translates into much longer barrier or burn-through times.

Generally, the smoke produced when the laminates 10 of the present invention burn are also less toxic than the smoke produced when prior art, paper based laminates burn. This is because the fillers used in the laminates 10 of the present invention may be chosen to limit the toxicity of the smoke. That is generally not possible with paper based laminates.

In addition, it should be appreciated that the paper based laminates of the prior art tend to absorb water. In contrast, the laminates 10 of the present invention incorporate a glass veil that absorbs little if any water. This is true even when subjected to high humidity environments. Thus, the laminates 10 of the present invention are particularly well suited for marine applications.

The following example is presented to further illustrate the invention, but it is not to be considered as limited thereto.

### EXAMPLE 1

Ten examples of a CPL of the present invention were prepared. In the first (Example 1), one layer (prepreg) of fiber reinforced veil was pressed on one layer of melamine formaldehyde impregnated decorative paper.

The glass fiber used in the glass veil layer was E-glass having a fiber diameter of 11 um and a length of 6 mm. The glass veil layer had a weight per unit area of 65 g/m². The glass veil layer included a polyvinyl alcohol binder at a content of 15 weight percent. The glass veil layer was impregnated with a binder and filler formulation including 32 weight percent resin (Phenolformaldehyde/melamineformaldehyde/hardener mixture) and 51 weight percent aluminum trihydrate.

The decorative paper layers each had a weight per unit area of 190 g/m² including 80 g/m² base weight paper and 110 g/m² melamine formaldehyde resin.

The stacked layers were pressed together at a pressure of 20 kg/m² at a temperature of 145 degrees C. for 60 seconds to produce a 0.35 mm thick laminate.

In the second (Example 2), two layers (prepregs) of fiber reinforced veil were pressed on one layer of melamine formaldehyde impregnated decorative paper.

The glass fibers used in the glass veil layers were E-glass having a fiber diameter of 11 um and a length of 6 mm. Each layer had a weight per unit area of 65 g/m². The glass veil layers both included a polyvinyl alcohol binder at a content of 14 weight percent. Both glass veils were impregnated with a binder and filler formulation including 29 weight percent resin (Phenol formaldehyde/melamine formaldehyde/hardener mixture), 40 weight percent aluminum trihydrate and 14 weight percent calcium carbonate.

The decorative paper layers each had a weight per unit area of 190 g/m² including 80 g/m² base weight paper and 110 g/m² melamine formaldehyde resin.

The stacked layers were pressed together at a pressure of 20 kg/m² at a temperature of 145 degrees C. for 60 seconds to produce a 0.55 mm thick laminate.

Additional examples 3-10 are presented below in Table 1 along with examples 1 and 2. Fire properties for Examples 2-5 under IMO A 653(16) are also presented.

TABLE 1

| | | | | | | | | | | | | Compara- |
|---|---|---|---|---|---|---|---|---|---|---|---|---|
| | | EX 1 | EX 2 | EX 3 | EX 4 | EX 5 | EX 6 | EX 7 | EX 8 | EX 9 | EX 10 | tive EX |
| Pressing temperature (EC) | | 145 | 145 | 145 | 145 | 145 | 145 | 145 | 190 | 190 | 190 | 160 |
| pressure (kg/m2) | | 20 | 20 | 20 | 20 | 20 | 20 | 20 | 40 | 40 | 40 | 25 |
| Pressing time (s) | | 60 | 60 | 60 | 60 | 60 | 60 | 60 | 30 | 45 | 60 | 30 |
| prepreg weight (g/m2) | | 375 | 375 | 375 | 375 | 375 | 375 | 375 | 375 | 375 | 375 | |
| # prepregs | | 1 | 2 | 3 | 2 | 3 | 2 | 1 | 1 | 2 | 3 | |
| ATH concentration in prepreg(%) | | 51 | 40 | 36 | 28.5 | 27 | 26 | 24 | 24 | 24 | 24 | |
| calciumcarbonate in prepreg(%) | | 0 | 14 | 19 | 28.5 | 27 | 26 | 24 | 24 | 24 | 24 | |
| resin content in prepreg(%) | | 32 | 29 | 28 | 26 | 33 | 32 | 35 | 35 | 35 | 35 | |
| glass content in laminate(g/m2) | | 65 | 130 | 195 | 130 | 195 | 130 | 65 | 65 | 130 | 195 | |
| laminate thickness (mm) | | 0.35 | 0.55 | 0.75 | 0.55 | 0.75 | 0.55 | 0.35 | 0.35 | 0.6 | 0.8 | 0.7 |
| Resistance to HCl solution (13% for 60 s) | | ok | ok | ok | ok | ok | ok | ok | ok | ok | Ok | ok |
| 2 hours immersion in boiling water | | | | | | | | | | | | |
| visual observation (blisters, delamination) | | ok | ok | ok | ok | ok | ok | ok | ok | ok | Ok | ok |
| water uptake (%) | | 0.65 | 3.8 | 5 | 1.4 | 3.5 | 1.3 | 0.1 | 7.3 | 6 | 7.9 | 10 |
| Cross cut test (adhesion) | | ok | ok | ok | ok | ok | ok | ok | ok | ok | Ok | ok |
| Fire properties required | | | | | | | | | | | | |
| IMO A 653(16) | | | | | | | | | | | | |
| Average heat for sustained burning | >1.5 | | >1.5 | >1.5 | >1.5 | >1.5 | | | | | | |
| (MJ/m2) | | | | | | | | | | | | |
| Critical flux at extinguishment | >20 | | 50.68 | 49.46 | 51.05 | 46.68 | | | | | | |
| (kW/m2) | | | | | | | | | | | | |
| Peak heat release (kW) | <4 | | 0.31 | 0.25 | 0.22 | 0.5 | | | | | | |
| Total heat release of the specimen | <0.7 | | 0.11 | 0.08 | 0.08 | 0.07 | | | | | | |
| (MJ) | | | | | | | | | | | | |

| | | | |
|---|---|---|---|
| Burn through times (s) Bunsenburner | 60 | >120 | 15 |

In addition, Table 1 includes a reference to a comparative example. This is a continuous pressed laminate of prior art design having one layer of melamine impregnated decorative paper (80 g/m² paper+110 g/m² melamine resin) and three layers of phenolic resin impregnated kraft paper (weight 240 g/m²; resin weight 45%). The layers were processed at a pressure of 25 kg/cm² at a temperature of 160 degrees C. for thirty seconds. The prior art CPL had a water uptake of 10% after immersion for two hours in boiling water.

When subjected to a Bunsen burner, the prior art based CPL burned through in 15 seconds. In contrast, the CPL of examples 1 and 2 of the present invention burned through in, respectively, 60 seconds and greater than 120 seconds. This demonstrates the enhanced fire performance characteristic of the CPL of the present invention.

The foregoing description of a preferred embodiment of the present invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

1. A continuous pressed laminate, comprising:
a first layer of resin impregnated paper; and
at least one layer of fiber reinforced veil, each layer of said fiber reinforced veil being impregnated with a binder and a filler composition;
wherein said at least one layer of fiber reinforced veil has a weight per unit area of between about 50 to about 1250 g/m² following impregnation and prior to pressing.

2. The continuous pressed laminate of claim 1, wherein said at least one layer of fiber reinforced veil has a weight per unit area of between about 75 to about 750 g/m² following impregnation and prior to pressing.

3. The continuous pressed laminate of claim 1, wherein said at least one layer of fiber reinforced veil has a weight per unit area of between about 100 to about 600 g/m² following impregnation and prior to pressing.

4. The continuous pressed laminate of claim 1, wherein said at least one layer of fiber reinforced veil has a base weight per unit area of between about 20 to about 200 g/m².

5. The continuous pressed laminate of claim 1, wherein said at least one layer of fiber reinforced veil has a base weight per unit area of between about 30 to about 120 g/m².

6. The continuous pressed laminate of claim 1, wherein said at least one layer of fiber reinforced veil has a base weight per unit area of between about 40 to about 100 g/m².

7. The continuous pressed laminate of claim 1, wherein said impregnated fiber reinforced veil comprises between about 2 and about 50 weight percent reinforcement fibers, between about 10 and about 70 weight percent resin and between about 0 and about 80 weight percent filler.

8. The continuous pressed laminate of claim 7, wherein said resin is selected from a group of resins consisting of phenol formaldehyde, melamine formaldehyde, urea formaldehyde, crosslinkable acrylates, crosslinkable acrylics, self-crosslinkable acrylates, self-crosslinkable acrylics, epychlorohydrin polyamide, epychlorohydrin polyamine, epoxy and mixtures thereof.

9. The continuous pressed laminate of claim 8, wherein said filler is selected from a group of fillers consisting of aluminum trihydrate, calcium carbonate, magnesium hydroxide, metal hydroxides, metal carbonates, titanium oxide, calcined clay, barium sulfate, magnesium sulfate, aluminum sulfate, zinc oxide, kaolin clay, chlorite, diatomite, feldspar, mica, nepheline syenite, pyrophyllite, silica, talc, wollastonite, montmorillonite, hectorite, saponite, magnesium carbonate, aluminum oxide, iron oxide, ethylenediamine phosphate, guanidine phosphate, melamine borate, melamine (mono, pyro, poly) phosphate, ammonium (mono, pyro, poly) phosphate, dicyandiamide condensates, expandable graphite, glass micro beads and mixtures thereof.

10. The continuous pressed laminate of claim 9, wherein said resin and filler composition includes between about 10 and about 60 weight percent resin and between about 0 and about 85 weight percent filler.

11. The continuous pressed laminate of claim 7, wherein said resin is a phenol formaldehyde/melamine formaldehyde/hardener mixture.

12. The continuous pressed laminate of claim 11, wherein said filler is selected from a group of fillers consisting of aluminum trihydrate, calcium carbonate, magnesium hydroxide and mixtures thereof.

13. The continuous pressed laminate of claim 12, wherein said resin is provided at a ratio of about 25-75% phenol formaldehyde, about 25-75% melamine formaldehyde and about 2-20% hardener.

14. The continuous pressed laminate of claim 13, wherein said resin and filler composition includes between about 10 and about 60 weight percent resin and between about 0 and about 85 weight percent filler.

15. The continuous pressed laminate of claim 1, further including a layer of backing paper wherein said veil is sandwiched between said first layer of resin impregnated paper and said backing paper.

16. The continuous pressed laminate of claim 1, further including a layer of parchment paper wherein said veil is sandwiched between said first layer of resin impregnated paper and said parchment paper.

17. The continuous pressed laminate of claim 1, further including a second layer of resin impregnated paper wherein said veil is sandwiched between said first and second layers of resin impregnated paper.

18. The continuous pressed laminate of claim 17, wherein said first and second layers of resin impregnated paper are melamine impregnated decorative paper.

19. The continuous pressed laminate of claim 1, wherein said fiber reinforced veil is woven.

20. The continuous pressed laminate of claim 1, wherein said fiber reinforced veil is nonwoven.

21. The continuous pressed laminate of claim 1, wherein said fiber reinforced veil is made from at least one layer of woven material and at least one layer of nonwoven material.

22. The continuous pressed laminate of claim 1, wherein said fiber reinforced veil includes reinforcing fibers selected from a group consisting of glass fibers, basalt fibers, silica fibers, inorganic fibers and mixtures thereof.

23. The continuous pressed laminate of claim 22, wherein said glass fibers are chopped.

24. The continuous pressed laminate of claim 23, wherein said chopped glass fibers are selected from a group consisting of chopped strands, chopped rovings, chopped individual glass fibers and mixtures thereof.

25. A method of making a continuous pressed laminate, comprising:
pressing a first layer of resin impregnated paper and at least one layer of fiber reinforced veil together at a pressure of between about 5 kg/cm² and about 60 kg/cm² while simultaneously heating said layers to a temperature of about 120° C. to about 250° C. to produce a laminate, said at least one layer of fiber reinforced veil having a weight per unit area of between about 50 to about 1250 g/m² following impregnation and prior to pressing.
